(19) United States
(12) Patent Application Publication
(10) Pub. No.: US 2024/0242900 A1
(43) Pub. Date: Jul. 18, 2024

(54) GRAPHENE-COPPER COATED ELECTRICAL CONTACT

(71) Applicants: ABB Schweiz AG, Baden (CH); Nanesa S.r.l., Arezzo (IT)

(72) Inventors: Anna Andersson, Västerås (SE); Su Zhao, Västerås (SE); Francesco Bertocchi, Roma (IT); Matteo Mulattieri, Albano Laziale (IT)

(21) Appl. No.: 18/559,451

(22) PCT Filed: Apr. 7, 2022
(86) PCT No.: PCT/EP2022/059242

§ 371 Date: Nov. 7, 2023

(30) Foreign Application Priority Data
May 10, 2021 (EP) 21173076.7

(51) Int. Cl. H01H 1/021; C25D 3/38; H01H 11/04; H01R 13/03; H01R 43/16

(52) U.S. Cl. CPC H01H 1/021; C25D 3/38; H01R 13/03; H01H 11/04; H01R 43/16

(57) ABSTRACT

An electrical contact including a substrate of an electrically conductive material, and a graphene-copper composite coating on the substrate. The graphene content in the coating is within the range of 0.1 to 2 wt %.

### TECHNICAL FIELD

The present disclosure relates to an electrical contact comprising a substrate and a coating on said substrate.

### BACKGROUND

Silver (Ag)-plated copper (Cu) is used as an electrical contact material for a range of both arcing contacts, e.g. in LV switch disconnectors, and non-arcing contact applications, e.g. power connectors. Ag is an excellent contact material with low contact resistance and anti-oxidation property. However, Ag material is expensive and sensitive to sulphur containing atmosphere.

### SUMMARY

It is an objective of the present invention to provide an improved electrical contact.

It has now been realized by the inventors that by using a graphene composite, the corrosion resistance of copper can be greatly improved, why a less expensive graphene-copper composite coating may be used instead of silver. The composite coating provides oxidation protection for the substrate material and prevents diffusion of the substrate material through the coating, also at relatively low graphene concentrations. By keeping graphene concentration low in the composite coating, the conductivity is not substantially impeded, why the composite coating can advantageously be used for electrical contacts, e.g. in a power connector or a switch-disconnector. The use of graphene in the contact may also reduce its friction, improve its electrical conductivity, improve its wear (e.g. arc) resistance and prolong its operational life.

According to an aspect of the present invention, there is provided an electrical contact comprising a substrate of an electrically conductive material, and a graphene-copper composite coating on the substrate. The graphene content in the coating is within the range of 0.1 to 2 wt %.

According to another aspect of the present invention, there is provided a contact arrangement comprising an embodiment of the electrical contact of the present disclosure.

According to another aspect of the present invention, there is provided a method of coating a substrate for an electrical contact. The method comprises providing a graphene-copper electrolytic solution comprising graphene and copper ions. The method also comprises coating the substrate by electrodeposition whereby the graphene and copper ions are co-deposited to form a graphene-copper composite coating on the substrate. The graphene content in the solution is within the range of 0.01-1.5 g/L.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic circuit diagram of a contact arrangement, in accordance with some embodiments of the present invention.

FIG. 2 is a schematic side view of an electrical contact, in accordance with some embodiments of the present invention.

FIG. 3 is a graph illustrating the evolution of contact resistance of a Cu reference contact, a Ag reference contact and a Cu-graphene contact (of the present invention) exposed to 130° C. temperature aging in a hot-air oven during 30 days.

FIG. 4 is a schematic sectional side view of an electrodeposition bath, in accordance with some embodiments of the present invention.

FIG. 5 is a schematic flow chart of some embodiments of a method of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

Herein the term graphene (G) is used collectively for carbon atoms in a 2D-honeycomb lattice in the form of mono-layer sheets, bi-layer sheets, few (3-5 layers)-layer sheets, or nano-platelets having a thickness of at most 50 nm, e.g. within the range of 1-50 nm. Also, when graphene is discussed herein, it should be understood that some of the graphene may be in the form of graphene oxide (GO) or reduced GO (rGO). Thus, the graphene may comprise only pure graphene or a mixture of pure graphene and GO and/or rGO.

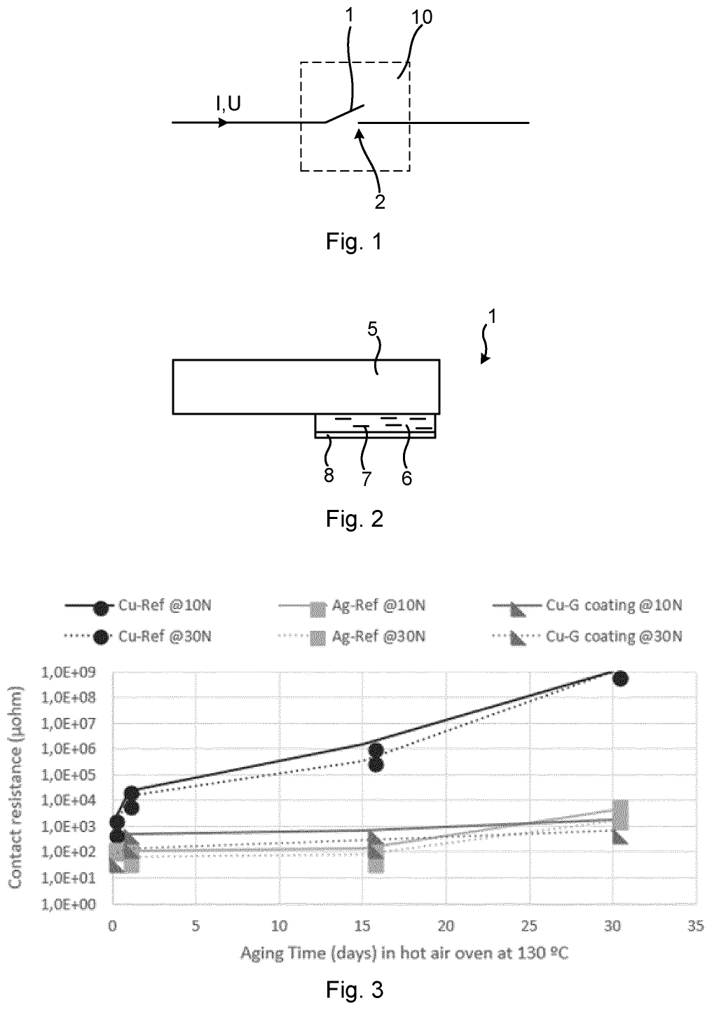

FIG. 1 illustrates a contact arrangement 10, arranged for conducting and/or switching an electrical current I having a voltage U, alternating current (AC) or direct current (DC), comprising a contact pair 2 comprising a contact 1. The contact arrangement may e.g. be or comprise a power connector (a type of stationary contact), configured for carrying the current I e.g. when it is connected to a load, or a switchgear such as a switch-disconnector, configured for switching and/or breaking the current I, in which case the contact 1 may be an arcing contact. It follows that, the contact arrangement 10, and thus the contact pair 2 and contact 1 thereof, may be configured to be conducting and non-arcing, as in a power connector, or conducting and arcing as in a switch-disconnector.

Ag-plated Cu is used as an electrical contact material for a range of both arcing contacts, e.g. in LV switch disconnectors, and non-arcing stationary contact applications, e.g. power connectors. Some embodiments of the present invention, with a G-Cu composite coating instead of Ag-plating, can be used for the same applications as Ag-plated Cu contacts.

The contact arrangement 10 is preferably for low voltage (LV) applications, having a nominal AC voltage of at most 1 kV, e.g. within the range of 0.1-1 kV, or a nominal DC voltage of at most 1.5 KV, e.g. within the range of 0.1-1.5 kV, or for applications of higher nominal voltages, e.g. of a nominal voltage up to 70 kV such as having a nominal AC or DC voltage within the range of 1-70 kV.

FIG. 2 illustrates the electrical contact 1, comprising a substrate 5 of an electrically conductive material, and a G-Cu composite coating 6 on said substrate, typically on a surface of the substrate such that the composite coating is in direct contact with the electrically conductive material of the substrate, without any intermediate layer. The composite coating 6 may have a thickness which is at most 100 μm, e.g. within a range of 0.1-100 μm or 1-50 μm.

The electrically conductive material of the substrate 5 may be metallic, e.g. comprising or consisting of (typically consisting of) Cu or aluminium (AI). Cu may be advantageously used since the use of Cu in both the substrate 5 and the composite coating 6 may improve adherence of the coating to the substrate.

The G content in the composite coating 6 is within the range of 0.1 to 2 percent by weight (wt %), e.g. within the range of 0.3 to 1 wt %, thus being a concentration which is low enough to not substantially impede the conductivity of the contact 1. The G content may still be high enough to reduce the friction of the contact 1, at a surface of the composite coating 6, to obviate the need for using a grease or other non-solid lubricant e.g. when the contact is used in a switch-disconnector. Preferably, the composite coating 6 is free of silver. For instance, the composite coating may consist of only G and Cu.

The G is preferably present as few-layer graphene sheets 7 (also called nano-platelets herein) in the coating 6, with a preferable thickness within the range of 1-50 nm. The G sheets 7 each has a lateral size, herein discussed as a longest diameter, which is several times larger than the thickness, resulting in the platelet form (flake or sheet form). In some embodiments, the sheets 7 each has a longest diameter within the range of 5-80 μm. The G in the composite coating 6 greatly improves the corrosion resistance. It is believed that the G sheets 7 may naturally align themselves with the substrate surface (e.g. as a result of electrodeposition discussed below), such that the platelets are generally arranged in parallel with the surface being coated. The G sheets 7 may prevent diffusion of atoms (e.g. Cu) of the substrate 5 through the coating 6, which is a known problem when using e.g. pure Ag coatings, further preventing oxide growth on the surface of the coated contact 1. The G sheets 7 may also effectively provide conductive pathways from the contact surface to the bulk limiting the effect of oxide layer resistance.

Thus, embodiments of the present invention, by using a G-Cu composite coating, even with relatively low graphene content, in the contact 1, may combine the advantageous properties of 1) low friction in dry conditions, on a similar level as a greased system, thanks to the lubricating properties of the graphene; 2) low contact resistance, which may be similar to that of pure silver rather than of pure copper, thanks at least in part to the low resistivity of graphene; and 3) high corrosion resistance in air at elevated temperatures, also leading to the maintaining of low contact resistance over time, thanks at least in part to the impeding of formation of an electrically insulating oxidised surface layer on the contact, and providing an electrical conduction pathway to the substrate 5.

FIG. 3 shows a graph of the evolution of contact resistance of a Cu reference contact, an Ag reference contact and a Cu-graphene contact (of the present invention) exposed to 130° C. temperature aging in a hot-air oven during 30 days. The contact resistance was measured at different mechanical contact loads (10 and 30 Newtons, N, respectively) vs. a silver counter electrode. As can be seen, the resistance for the Cu reference increases rapidly with exposure time, while the Cu-graphene coated Cu contact shows limited increase, very similar to the contact resistance increase for the Ag reference.

Referring again to FIG. 2, to package the composite coating 6, a thinner coating 8 of pure Cu may be applied on top of the composite coating. The pure Cu coating may have a thickness which is at most 20 μm, e.g. within a range of 0.1-20 μm or 1-10 μm. The combined thickness of the composite coating 6 and the pure Cu coating may be at most 100 μm, e.g. within a range of 0.1-100 μm or 1-20 μm.

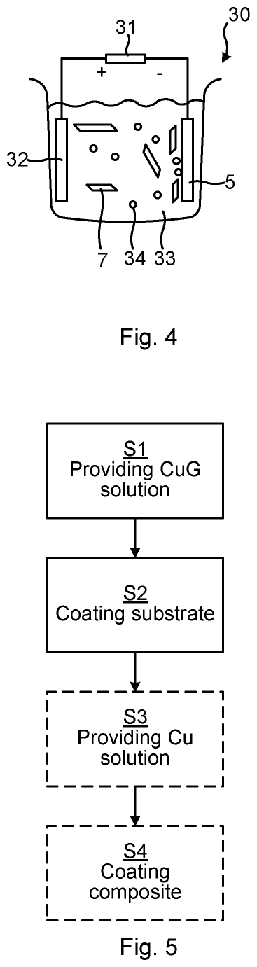

FIG. 4 illustrates an electrodeposition arrangement or bath 30 for electrodeposition (also called electroplating) of the composite coating 6 (in applicable parts also relevant for electrodeposition of the pure Cu coating 8 if used).

A G-Cu electrolytic solution 33, typically aqueous, comprises graphene 7, typically in the form of nano-platelets, and copper ions 34. The substrate 5 functions as a cathode and is, similar as a corresponding anode 32, e.g. a Cu anode, connected to a voltage source 31. By applying a voltage, by the voltage source 31, between the substrate 5 and the anode 32, the graphene nano-platelets 7 and Cu ions 34 are co-deposited onto a surface of the substrate 5 to form the composite coating 6. Similarly, for the pure Cu coating 8, if desired, an electrolytic solution 33 comprising Cu ions 34, but no G 7, is used.

The Cu ions 34 are typically provided by dissolving a copper salt in the electrolytic solution 33. Examples of Cu salts which may be used include CuSO₄ and/or CuCl₂. In some embodiments, the copper salt content in the solution 33 is within the range of 50-250 grams per litre (g/L). The graphene content in the solution 33 is typically within the range of 0.01-1.5 g/L.

FIG. 5 is a flow chart illustrating some embodiments of the method of the present invention. The method is for coating a substrate 5 for an electrical contact 1, e.g. a contact 1 as discussed herein. A graphene-copper electrolytic solution 33 comprising copper ions 34 and graphene 7 is provided S1. Then, the substrate 5 is coated S2 by electrodeposition whereby the graphene 7 and copper ions 34 are co-deposited to form a graphene-copper composite coating 6 on the substrate 5.

In some embodiments, the method further comprises forming a pure copper coating 8 on top of the composite coating 6, typically directly in contact with the composite coating without any intermediate layer. Thus, the method may comprise providing S3 a copper electrolytic solution comprising copper ions 34, and then, coating S4 the graphene-copper composite coating 6 by electrodeposition whereby the copper ions 34 are deposited to form a pure copper coating 8 on top of the composite coating 6.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. An electrical contact comprising:
a substrate of an electrically conductive material; and
a graphene-copper composite coating on the substrate;
wherein the graphene content in the coating is within the range of 0.1 to 2 wt %.

2. The contact of claim 1, wherein the coating is free of silver.

3. The contact of claim 1, wherein the substrate material is or comprises copper and/or aluminium, preferably wherein the substrate material is copper.

4. The contact of claim 1, wherein the graphene is in the form of sheets having a thickness within the range of 1-50 nm.

5. The contact of claim 4, wherein the sheets have a longest diameter within the range of 5-80 μm.

6. The contact of claim 1, further comprising:
a pure copper coating on top of the composite coating.

7. A contact arrangement comprising at least one electrical contact including a substrate of an electrically conductive material; and
a graphene-copper composite coating on the substrate;
wherein the graphene content in the coating is within the range of 0.1 to 2 wt %.

8. The contact arrangement of claim 7, wherein the contact arrangement is configured for a nominal voltage of at most 70 kV.

9. The contact arrangement of claim 7, wherein the contact arrangement is a power connector.

10. The contact arrangement of claim 7, wherein the contact arrangement is a switch-disconnector.

11. A method of coating the substrate for the electrical contact including a substrate of an electrically conductive material; and
a graphene-copper composite coating on the substrate;
wherein the graphene content in the coating is within the range of 0.1 to 2 wt %, the method comprising:
providing a graphene-copper electrolytic solution including graphene and copper ions; and
coating the substrate by electrodeposition whereby the graphene and copper ions are co-deposited to form a graphene-copper composite coating on the substrate;
wherein the graphene content in the solution is within the range of 0.01-1.5 g/L.

12. The method of claim 11, wherein the copper ions are provided from a copper salt dissolved in the electrolytic solution, the salt including CuSO₄ and/or CuCl₂.

13. The method of claim 12, wherein the copper salt content in the solution is within the range of 50-250 g/L.

14. The method of claim 11, further comprising:
providing a copper electrolytic solution including copper ions; and
coating the graphene-copper composite coating by electrodeposition whereby the copper ions are deposited to form a pure copper coating on top of the composite coating.

15. The contact of claim 2, wherein the substrate material is or comprises copper and/or aluminium, preferably wherein the substrate material is copper.

16. The contact of claim 2, wherein the graphene is in the form of sheets having a thickness within the range of 1-50 nm.

17. The contact of claim 2, further comprising:
a pure copper coating on top of the composite coating.

18. The contact arrangement of claim 8, wherein the contact arrangement is a power connector.

19. The contact arrangement of claim 8, wherein the contact arrangement is a switch-disconnector.
